(19) United States
(12) Patent Application Publication
(10) Pub. No.: US 2026/0043482 A1
(43) Pub. Date: Feb. 12, 2026

(54) VALVE MECHANISM AND OPERATING METHOD OF THE SAME

(71) Applicant: HIGHLIGHT TECH CORP., Tainan City (TW)

(72) Inventors: Yu-Hsiang Chen, Tainan City (TW); CHUN-SHU HSU, Tainan City (TW); MING-SHENG TSAI, Tainan City (TW); YU-WEI CHEN, Tainan City (TW); SZU-MIN LIN, Tainan City (TW); WEN-YUNG YEH, Tainan City (TW); CHWUNG-SHAN KOU, Tainan City (TW); CHIEN-CHENG CHANG, Tainan City (TW)

(73) Assignee: HIGHLIGHT TECH CORP., Tainan City (TW)

(21) Appl. No.: 19/265,871

(22) Filed: Jul. 10, 2025

Related U.S. Application Data
(60) Provisional application No. 63/671,964, filed on Jul. 16, 2024.
(60) Provisional application No. 63/684,347, filed on Aug. 17, 2024.

(30) Foreign Application Priority Data
Jun. 9, 2025 (TW) 114121443

(51) Int. Cl. F16K 3/18

(52) U.S. Cl. CPC F16K 3/186

(57) ABSTRACT

Disclosed is a valve mechanism and an operating method of the same configured for optionally sealing or opening a first opening port on a cavity. The valve mechanism comprises a displacement element, a carrier plate, a sealing disc and a guide element. The displacement element drives the sealing disc to reciprocate via the carrier plate, and the guide element correspondingly guides an orientation of a sealing surface of the sealing disc according to an orientation of a sealing surface of the first opening port on the cavity when the sealing disc reciprocates, so that the sealing surface of the sealing disc is parallel to the sealing surface of the first opening port on the cavity, thereby symmetrically applying force to seal the first opening port on the cavity.

### CROSS-REFERENCE TO RELATED APPLICATION

This application claims the benefit of priority form a provisional application of U.S. Patent Application No. 63/671,964, filed on Jul. 16, 2024; a provisional application of U.S. Patent Application No. 63/684,347, filed on Aug. 17, 2024; and Taiwan Patent Application No. 114121443, filed on Jun. 9, 2025, each of which is hereby incorporated herein by reference in its entireties.

### BACKGROUND OF THE DISCLOSURE

### 1. Field of Disclosure

The disclosure relates to a valve mechanism and an operating method of the same.

### 2. Related Art

Most conventional vacuum valves use rubber elastic materials commonly known as O-rings as sealing elements between the valve plate and the valve body. Since O-rings achieve the required scaling effect through extrusion deformation, O-rings are only suitable for valve bodies that do not require high sealing performance. Therefore, this type of sealing element cannot be used in high vacuum systems and cannot be used in high temperature environments.

Although some high vacuum systems use all-metal valves to replace non-all-metal valves containing rubber sealing elements, the sealing surface is formed by two metal layers abutting and connecting with each other. Therefore, the closing force applied increases with the increase in a number of times of opening and closing of the vacuum valve, and its service life will be shortened. In addition, the dimensional changes caused by heating or cooling of the metal layer will cause relative movements between the two metal layers and cause shear deformation to destroy the sealing surface. Moreover, since conventional vacuum valves use supporting plates to push the sealing disc, the non-driving supporting plates (such as the supporting plates positioned at an upper position) often fall off.

### SUMMARY OF THE DISCLOSURE

In view of the above, one object of the disclosure is to provide a valve mechanism configured for optionally sealing or opening a first opening port on a cavity, the valve mechanism comprises: a displacement element configured for performing a first reciprocating motion along a first axial direction; two carrier plates respectively movably located on two sides of the displacement element for performing a second reciprocating motion along the first axial direction along with the first reciprocating motion performed by the displacement element, and the displacement element further drives the two carrier plates to perform a third reciprocating motion in opposite directions along a second axial direction; a sealing disc configured for performing the second reciprocating motion along the first axial direction along with the first reciprocating motion performed by the displacement element, and the sealing disc performs a fourth reciprocating motion between an intermediate position and a hard-sealing position correspondingly through the third reciprocating motion of one of the two carrier plates; and a guide element configured for guiding an orientation of a sealing surface of the sealing disc correspondingly according to an orientation of a sealing surface of the first opening port on the cavity during a process of the fourth reciprocating motion performed by the sealing disc and moving from the intermediate position to the hard-sealing position, causing the sealing surface of the sealing disc to be parallel to the sealing surface of the first opening port on the cavity, thereby symmetrically applying force to seal the first opening port on the cavity.

The disclosure further provides an operating method of the valve mechanism, comprising following steps of: providing the aforementioned valve mechanism; performing a driving step, causing the displacement element to perform the first reciprocating motion along the first axial direction, so that the two carrier plates performing the second reciprocating motion along the first axial direction along with the first reciprocating motion of the displacement element, and causing the displacement element to further drive the two carrier plates to perform the third reciprocating motion in opposite directions along the second axial direction, wherein the sealing disc performs the second reciprocating motion along the first axial direction along with the first reciprocating motion of the displacement element, and the sealing disc performs the fourth reciprocating motion between the intermediate position and the hard-sealing position through the third reciprocating motion of one of the two carrier plates; and performing a guiding step, wherein the guide element guides the orientation of the sealing surface of the sealing disc according to the orientation of the sealing surface of the first opening port on the cavity during a process of the sealing disc moving from the intermediate position to the hard-sealing position, so that the sealing surface of the sealing disc is parallel to the sealing surface of the first opening port on the cavity, thereby symmetrically applying force to seal the first opening port on the cavity.

In order to enable the examiner to have a further understanding and recognition of the technical features of the disclosure, preferred embodiments in conjunction with detailed explanation are provided as follows.

### BRIEF DESCRIPTION OF THE DRAWINGS

FIG. 1 is a perspective view of a valve mechanism of a first embodiment of the disclosure.

FIG. 2 is a front view of the valve mechanism of the first embodiment of the disclosure for sealing or opening a cavity, wherein a displacement element reaches a fully retracted height H1.

FIG. 3 is a front view of the valve mechanism of the first embodiment of the disclosure for sealing or opening the cavity, wherein the displacement element reaches a semi-extended height H2 and a sealing disc reaches an intermediate position W1.

FIG. 4 is a side view of the valve mechanism of the first embodiment of the disclosure for sealing the cavity, wherein the sealing disc reaches a hard-sealing position W2.

FIG. 5A, FIG. 5B, and FIG. 5C are schematic diagrams of processes of the valve mechanism shown in FIG. 1 sealing the cavity, and only partial structures are shown, wherein FIG. SA shows that the displacement element reaches the semi-extended height H2, FIG. 5B shows that the displacement element moves in a distance difference (spacing D1) to drive the sealing disc to move positionally, and FIG. 5C shows that the displacement element drives the sealing disc to reach the hard-sealing position W2.

FIG. 6 is a schematic diagram of a structure of a guide element of the first embodiment of the disclosure, wherein FIG. 6(A) is a front view and FIG. 6(B) is a side view.

FIG. 7 is a perspective view of an implementation mode of the valve mechanism of a second embodiment of the disclosure.

FIG. 8 is a side view of FIG. 7.

FIG. 9A, FIG. 9B, and FIG. 9C are schematic diagrams of processes of the valve mechanism shown in FIG. 7 sealing the cavity, and only partial structures are shown, wherein FIG. 9A shows that the displacement element reaches the semi-extended height, FIG. 9B shows that the displacement element moves in a distance difference to drive the sealing disc to move positionally, and FIG. 9C shows that the displacement element drives the sealing disc to reach the hard-sealing position.

FIG. 10 is a schematic diagram of of the guide element and an pressing plate of the second embodiment of the disclosure, wherein FIG. 10(A) and 10(C) are a side view and a front view of the pressing plate respectively, and FIG. 10(B) and 10(D) are a side view (with the sealing disc) and a front view of the guide element respectively.

FIG. 11 is a side view of another feasible mode of the valve mechanism of the second embodiment of the disclosure.

FIG. 12A, FIG. 12B, and FIG. 12C are schematic diagrams of processes of the valve mechanism shown in FIG. 11 sealing the cavity, and only partial structures are shown, wherein FIG. 12A shows that the displacement element reaches the semi-extended height, FIG. 12B shows that the displacement element moves in a distance difference to drive the sealing disc to move positionally, and FIG. 12C shows that the displacement element drives the sealing disc to reach the hard-sealing position.

FIG. 13 is a perspective view of the valve mechanism of a third embodiment of the disclosure.

FIG. 14A, FIG. 14B, and FIG, 14C are schematic diagrams of processes of the valve mechanism shown in FIG. 13, and only partial structure is shown, wherein FIG. 14A shows that the displacement element reaches the semi-extended height, FIG. 14B shows that the displacement element moves in a distance difference to drive the sealing disc to move positionally, and FIG. 14C shows that the displacement element drives the sealing disc to reach the hard-sealing position.

FIG. 15 is a cross-sectional view of a first implementation mode of the sealing disc of the disclosure, wherein surface heights of bottom sides of an auxiliary seat and a coupling seat are the same.

FIG. 16 is a cross-sectional view of the first implementation mode of the sealing disc of the disclosure, wherein surface heights of the bottom sides of the auxiliary seat and the coupling seat are different.

FIG. 17 is a cross-sectional view of a second implementation mode of the sealing disc of the disclosure.

FIG. 18 shows a flowchart of the valve mechanism of the disclosure for sealing the cavity.

### DETAILED DESCRIPTION OF THE DISCLOSURE

In order to understand the technical features, content and advantages of the disclosure and its achievable efficacies, the disclosure is described below in detail in conjunction with the figures, and in the form of embodiments, the figures used herein are only for a purpose of schematically supplementing the specification, and may not be true proportions and precise configurations after implementation of the disclosure; and therefore, relationship between the proportions and configurations of the attached figures should not be interpreted to limit the scope of the claims of the disclosure in actual implementation. In addition, in order to facilitate understanding, the same elements in the following embodiments are indicated by the same referenced numbers. And the size and proportions of the components shown in the drawings are for the purpose of explaining the components and their structures only and are not intending to be limiting.

Unless otherwise noted, all terms used in the whole descriptions and claims shall have their common meaning in the related field in the descriptions disclosed herein and in other special descriptions. Some terms used to describe in the present disclosure will be defined below or in other parts of the descriptions as an extra guidance for those skilled in the art to understand the descriptions of the present disclosure.

The terms such as “first”, “second”, “third” and “fourth” used in the descriptions are not indicating an order or sequence, and are not intending to limit the scope of the present disclosure. They are used only for differentiation of components or operations described by the same terms.

Moreover, the terms “comprising”, “including”, “having”, and “with” used in the descriptions are all open terms and have the meaning of “comprising but not limited to”.

A valve mechanism of the disclosure is suitable for optionally sealing or opening a first opening port on a cavity. The valve mechanism of the disclosure could adjust an orientation relative to the first opening port of the cavity in advance through a guide element, so that a sealing disc could symmetrically apply force to seal the first opening port on the cavity, wherein the sealing disc seals the first opening port in a manner of horizontal contact and applying force horizontally (referred to as horizontal sealing or parallel scaling), and could even achieve good contact with the first opening port through uniform stress distribution and contact pressure distribution. The disclosure could optionally omit using non-metallic sealing parts (such as gaskets or O-rings) commonly used in asymmetric force sealing technologies such as conventional non-horizontal sealing (that is, a sealing surface of the sealing disc contacts a sealing surface of the first opening port before adjusting an orientation), and the disclosure could effectively reduce an abrasion phenomenon caused by non-uniform stress distribution and contact pressure distribution in conventional non-horizontal sealing technology. The valve mechanism of the disclosure could realize an all-metal valve with an automatic or active guide design, and the disclosure is not limited thereto. The valve mechanism of the disclosure and the cavity to which it is applicable have no specific restrictions on materials, and could be made of all-metal material or non-all-metal material respectively. For example, the cavity could be, a cavity of various vacuum valves. In addition, the cavity to which the valve mechanism of the disclosure is applicable is not limited to a specific structure, form or material. Any cavity that could be used for the valve mechanism to seal or open the first opening port on the cavity belongs to a scope of application of the disclosure. The valve mechanism of the disclosure could be, for example, a single-sided sealing type or a double-sided sealing type, which means that the valve mechanism of the disclosure could not only symmetrically apply force to seal the first opening port on the cavity, but also optionally and synchronously apply force to symmetrically seal the first opening port and a second opening port on the cavity.

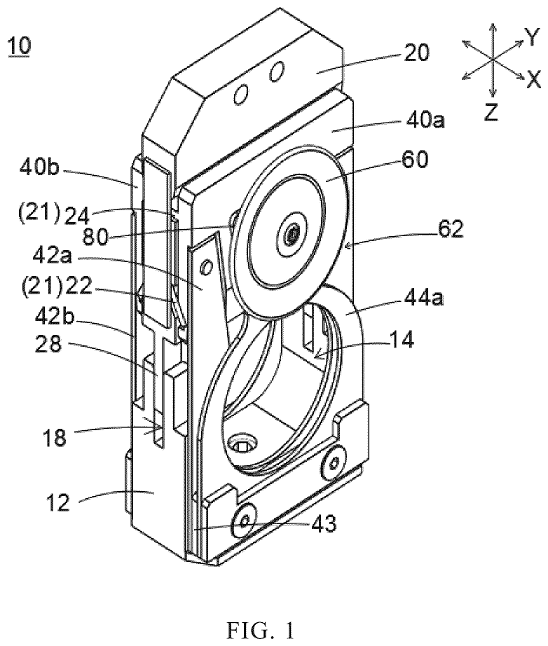

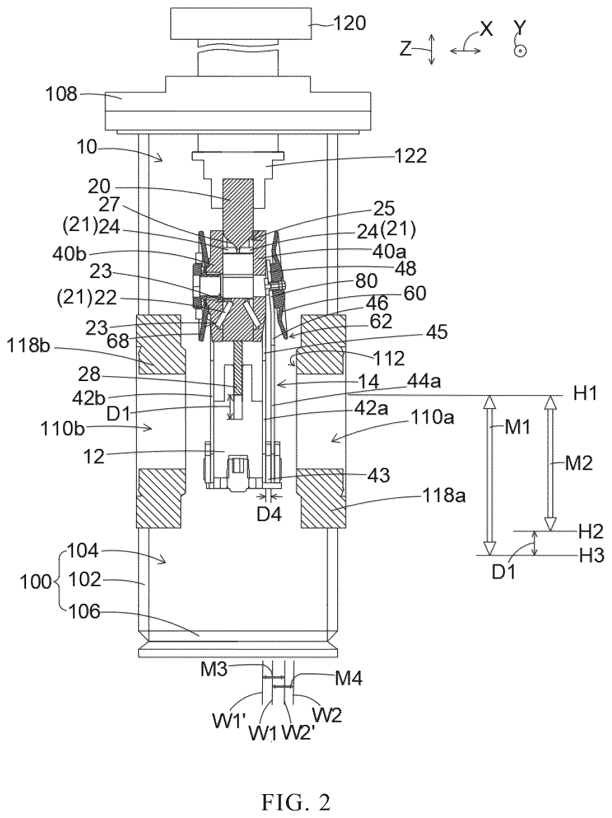

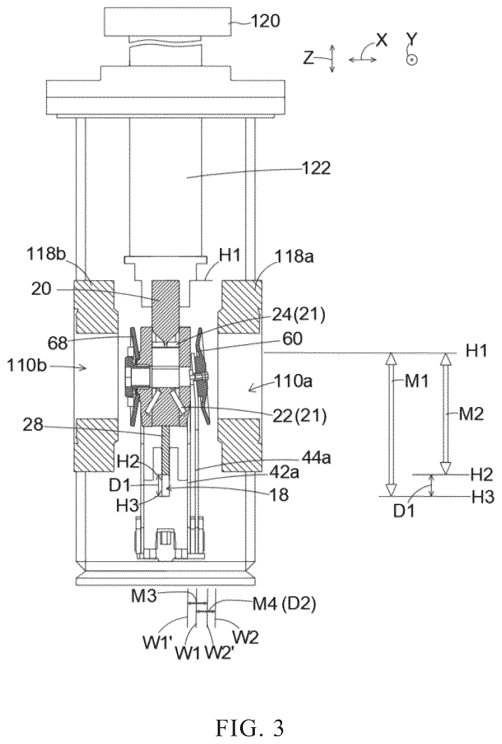

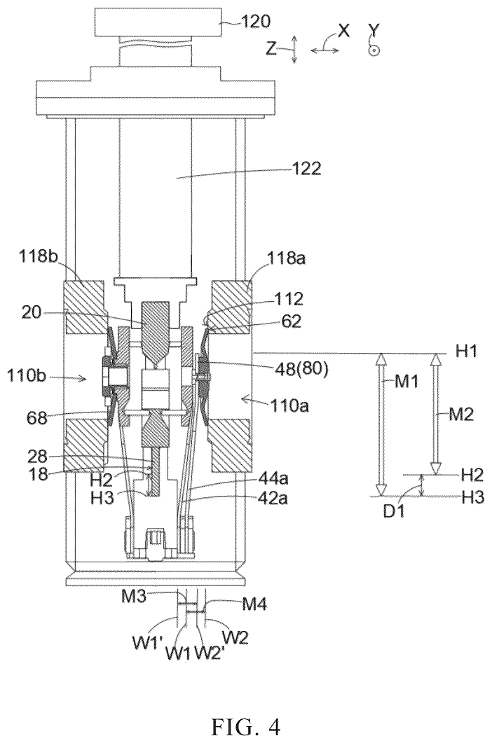

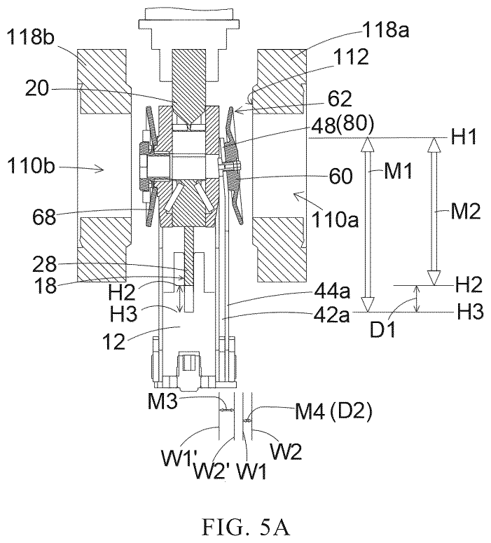

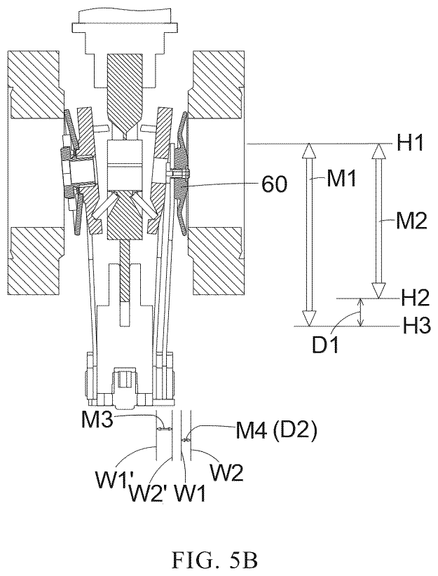

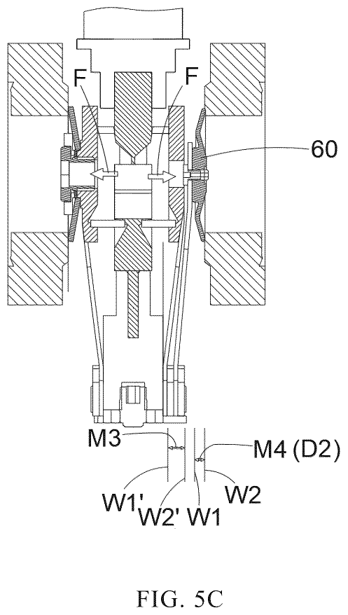

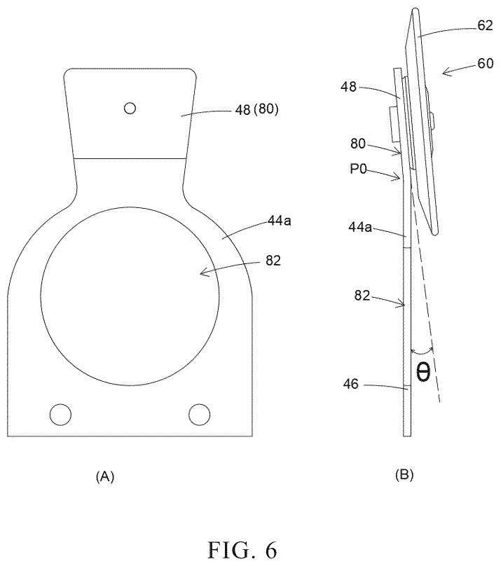

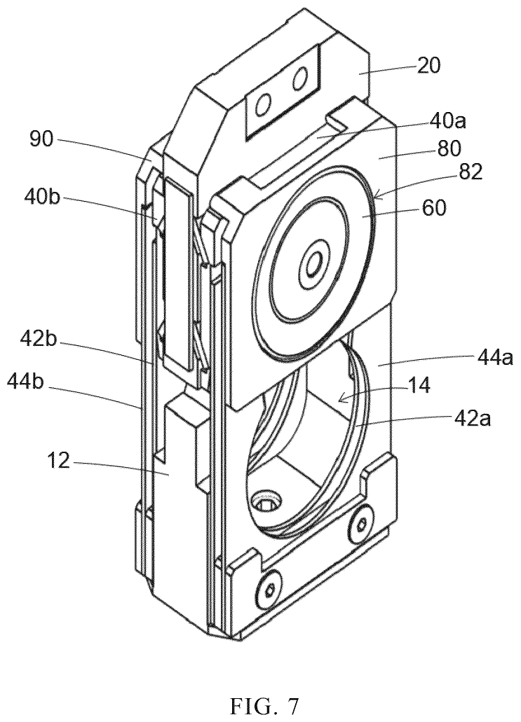

Please refer to FIGS. 1 to 6 and other figures, a valve mechanism 10 of a first embodiment of the disclosure is used to seal or open a first opening port 110a on a cavity 100. The valve mechanism 10 and the cavity 100 constitute a valve device. The cavity 100 mainly comprises a cavity wall 102, a cavity bottom 106, a cavity top 108 and an accommodating space 104, wherein the accommodating space 104 is mainly formed by surrounding by the cavity wall 102, the cavity bottom 106 and the cavity top 108, and the valve mechanism 10 is disposed in the accommodating space 104 of the cavity 100. The cavity 100 further optionally has a second opening port 110b, and the second opening port 110b is, for example, positioned on an opposite side of the first opening port 110a. The first opening port 110a and the second opening port 110b are, for example, the cavity walls 102 on two opposite sides of the cavity 100 and provided with an opening thereon respectively, or the first opening port 110a and the second opening port 110b are, for example, a first flange 118a and a second flange 118b respectively disposed on the cavity walls 102 on two opposite sides of the cavity 100 and provided with an opening thereon respectively. In order to facilitate the description of implementation modes of the disclosure, the following mainly takes an operation mode of the valve mechanism 10 closing the first opening port 110a on the cavity 100 as an example. However, a person having ordinary skill in the art to which the disclosure pertains should be able to understand how the valve mechanism 10 of the disclosure opens the first opening port 110a based on the disclosure of the disclosure, so it will not be repeated here.

The valve mechanism 10 of the disclosure mainly comprises a displacement element 20, two carrier plates 40a and 40b, a sealing disc 60 and a guide element 80. The displacement element 20 moves the sealing disc 60 in sequence along two different axial directions (e.g., Z-axis direction and X-axis direction) via at least one of the two carrier plates 40a and 40b (e.g., the carrier plate 40a). A. feature of the valve mechanism 10 of the disclosure is that the guide element 80 (or a first correction element or orientation guide element) could pre-adjust an orientation of a sealing surface 62 of the sealing disc 60 according to an orientation of a sealing surface 112 of the first opening port 110a, so that when (or at the moment) or before the sealing surface 62 of the sealing disc 60 contacts the sealing surface 112 of the first opening port 110a, the sealing surface 62 of the sealing disc 60 is guided (or corrected) to be substantially (e.g., completely) parallel to the sealing surface 112 of the first opening port 110a, and a technical efficacy of symmetrically applying force to seal the first opening port 110a is achieved by contacting the first opening port 110a in parallel through uniform stress distribution and contact pressure distribution. Wherein, the Z-axis direction and X-axis direction are, for example, perpendicular to each other, and both are perpendicular to a third axial direction (e.g., Y-axis direction).

For example, in the valve mechanism 10 of the disclosure, the displacement element 20 is, for example, a block, wherein the displacement element 20 is, for example, driven by a driving device 120, and performs a first reciprocating motion M1 along a first axial direction Z (for example, the Z-axis direction), so as to move a position between, for example, a fully retracted height H1 and a fully extended height H3. The driving device 120 could be, for example, a driving device such as a pneumatic or an electric driving cylinder, which has, for example, a moving rod (for example, a piston rod), and could be, for example, fully or partially controlled by manual control, automatic control, or automatic pressure control (APC). The driving device 120 is, for example, connected to the displacement element 20 via a moving rod 122, and the displacement element 20 (for example, its bottom side) could be moved positionally between the fully retracted height H1 and the fully extended height H3 by retracting or extending the moving rod 122. Taking the driving device 120 as a pneumatic driving cylinder as an example, the disclosure could achieve an effect of smooth closing, smooth opening or smooth actuation by, for example, controlling an air pressure or an airflow provided to the pneumatic driving cylinder, wherein the valve mechanism 10 of the disclosure further optionally comprises a solenoid valve, a piezoelectric pressure regulating valve or a voice coil pressure regulating valve to control an air pressure or an airflow provided to the pneumatic driving cylinder. During a process of the displacement element 20 performing the first reciprocating motion M1 along the first axial direction Z, the driving device 120 (e.g., a pneumatic or an electric driving device) could optionally drive the displacement element 20 with a single pressure value and/or a speed value, and/or drive the displacement element 20 with a plurality of pressure values and/or speed values. In addition, the driving device 120 is not limited to driving the displacement clement 20 by open-loop control or closed-loop control.

In the valve mechanism 10 of the disclosure, the two carrier plates 40a and 40b are respectively movably positioned on two sides of the displacement element 20, for performing a second reciprocating motion M2 along the first axial direction Z along with the displacement element 20 performing the first reciprocating motion M1 along the first axial direction Z, so as to simultaneously move a position along with the displacement element 20 moving positionally between the fully retracted height H1 and a semi-extended height H2. For example, in the valve mechanism 10 of the disclosure, the two carrier plates 40a and 40b are respectively movably positioned on the two sides of the displacement element 20, for example, via at least one supporting element 21 [e.g., at least one supporting plate 22 (e.g., four), at least one tenon plate 24 (e.g., four), and/or the at least one supporting plate 22 (e.g., two) with the at least one tenon plate 24 (e.g., two)]. The displacement element 20 and the two carrier plates 40a and 40b could, for example, respectively have a limiting groove 23, and the supporting plate 22 could be, for example, a strip-shaped rod and its two ends are movably accommodated in the limiting grooves 23 of the displacement element 20 and the two carrier plates 40a and 40b. Alternatively, the disclosure could optionally replace part or all of the supporting plates 22 with the tenon plates 24, for example, the displacement element 20 could optionally comprise a guide groove 25, wherein a top surface of the guide groove 25 is a guide surface 27 (for example, composed of a single slope or including a plurality of different slopes), one end of the tenon plate 24 is fixedly disposed on the two carrier plates 40a and 40b/or the carrier plate 40a or 40b and another end extends toward the displacement element 20. The tenon plate 24 is, for example, but not limited to, integrally formed on the two carrier plates 40a and 40b/or the carrier plate 40a or 40b. The disclosure uses the tenon plates 24 to replace part or all of the supporting plates 22 is conducive to solving the common and unavoidable problem of the supporting plate 22 at an upper position falling off in the conventional technology.

Moreover, moving directions of the first reciprocating motion M1 and the second reciprocating motion M2 are, for example, the same (for example, when a valve device composed of the valve mechanism 10 and the cavity 100 is to be changed from a fully open state to a semi-open and closed state, it is moved from a top to a bottom of the figures, and when the valve device is to be changed from a semi-open and closed state to a fully open state, it is moved from a bottom to a top of the figures), but the first reciprocating motion M1 and the second reciprocating motion M2 have different path lengths (for example, a first motion path of the first reciprocating motion M1 is more than a second motion path of the second reciprocating motion M2 by a distance difference, such as a spacing D1). Therefore, when the displacement element 20 continues to move its position during a part of process of the first reciprocating motion M1 (i.e., the extra distance difference, the spacing D1), the displacement element 20 could pivotally expand or retract the supporting element 21, thereby further driving the two carrier plates 40a and 40b to perform a third reciprocating motion M3 along a second axial direction X (e.g., X-axis direction) in opposite directions (e.g., directions moving away from or approaching each other) between an intermediate position W1′ (i.e., semi-opening and closing position, or partially open position) and a hard-sealing position W2′, thereby correspondingly enabling the sealing disc 60 to perform a fourth reciprocating motion M4 between the intermediate position W1 (i.e., semi-opening and closing position, or partially open position) and the hard-sealing position W2. In addition, since the displacement element 20 unfolds the supporting element 21 by pivoting to cause the carrier plates 40a and 40b to perform the third reciprocating motion M3, moving distances of upper and lower sides of the carrier plates 40a and 40b will be unequal, and the higher a position, the greater a distance (gap) between the carrier plates 40a and 40b and the displacement element 20, so it is easier to cause the movably inserted supporting plate 22 (especially the supporting plate 22 positioned on an upper side) to fall off during a driving process. In other words, an embodiment of the disclosure shown in FIG. 1 uses a combination of the tenon plate 24 and the guide groove 25 to replace a combination of part or all of the supporting plates 22 and the limiting groove 23 is conducive to solving the common and unavoidable problem of falling off of plate when the conventional technology drives the supporting plate 22 to pivot and displace.

It could be known from the above that the two carrier plates 40a and 40b of the valve mechanism 10 of the disclosure could perform the second reciprocating motion M2 along the first axial direction Z along with the first reciprocating motion M1 performed by the displacement element 20 along the first axial direction Z, and the sealing disc 60 could perform the fourth reciprocating motion M4 between the intermediate position WI and the hard-sealing position W2 correspondingly through the third reciprocating motion M3 of the carrier plate 40a. For example, the sealing disc 60 is positioned on a side of one of the two carrier plates 40a and 40b, such as the sealing disc 60 is movably disposed adjacent to a side of the carrier plate 40a or fixedly disposed on a side of the carrier plate 40a, so that the sealing disc 60 could move its position through displacements of the carrier plate 40a in the second reciprocating motion M2 and the third reciprocating motion M3, and relative positions and/or orientation relationships between the sealing disc 60 and the carrier plate 40a could be changed or fixed. For example, in the first embodiment of the disclosure, the sealing disc 60 is fixedly disposed on a second elastic plate 44a described later (that is, the sealing disc 60 is not disposed on the carrier plate 40a), so as to be movably positioned on a side of the carrier plate 40a. In other words, the sealing disc 60 could perform the fourth reciprocating motion M4 between the intermediate position WI and the hard-sealing position W2 correspondingly through the third reciprocating motion M3 of the carrier plate 40a. The disclosure is illustrated by taking the displacement element 20 as a plate body (for example, a rectangular plate body) as an example, but the disclosure is not limited thereto. As long as the two carrier plates 40a and 40b could perform the second reciprocating motion M2 and the third reciprocating motion M3 in sequence through the first reciprocating motion M1 performed by the displacement element 20, the displacement element 20 of any form (that is, shape and structure) belongs to a scope of protection claimed by the disclosure. In addition, the two carrier plates 40a and 40b of the disclosure are not limited to having a same shape or different shapes, as long as the two carrier plates 40a and 40b could be positioned between the displacement element 20 and the sealing disc 60, and are capable of moving the sealing disc 60 along two different axial directions (e.g., Z-axis direction and X-axis direction) sequentially in the second reciprocating motion M2 and the third reciprocating motion M3 along with the first reciprocating motion M1 of the displacement element 20, the two carrier plates 40a and 40b of a same shape or different shapes fall within a scope of protection claimed by the disclosure, A feature of the valve mechanism 10 of the disclosure is that the valve mechanism 10 has a guide element 80 for directly or indirectly adjusting an orientation of the sealing surface 62 of the sealing disc 60, for example, adjusting the sealing surface 62 of the sealing disc 60 automatically or actively (or even passively) from any orientation to be parallel to the sealing surface 112 of the first opening port 110a. For example, the guide element 80 correspondingly guides an orientation of the sealing surface 62 of the sealing disc 60 according to an orientation of the sealing surface 112 of the first opening port 110a on the cavity 100 during a process of the fourth reciprocating motion M4 (for example, moving from the intermediate position WI to the hard-sealing position W2) performed by the sealing disc 60, so that the sealing surface 62 of the sealing disc 60 is parallel to the sealing surface 112 of the first opening port 110a on the cavity 100, so as to symmetrically apply force to seal the first opening port 110a on the cavity 100. The above-mentioned “guiding” (or called adjusting or correcting) refers to pre-adjusting an orientation of the sealing surface 62 of the sealing disc 60, so that the sealing surface 62 of the sealing disc 60 is parallel to the sealing surface 112 of the first opening port 110a in advance when (or at the moment) or before contacting the sealing surface 112 of the first opening port 110a on the cavity 100, and after the sealing surface 62 and the sealing surface 112 contact each other, the sealing surface 62 of the sealing disc 60 could move parallel relative to the sealing surface 112 of the first opening port 110a, so that the sealing disc 60 could be closely abutted against the first opening port 110a on the cavity 100 to achieve an airtight sealing effect. It could be known from the above that the disclosure does not adjust an orientation of the sealing surface 62 of the sealing disc 60 after the sealing surface 62 of the sealing disc 60 contacts the sealing surface 112 of the first opening port 110a on the cavity 100.

The valve mechanism 10 of the disclosure further comprises two first elastic plates 42a and 42b and the second elastic plate 44a. The two carrier plates 40a and 40b are respectively disposed on first sides (e.g., top sides) of the two first elastic plates 42a and 42b and are positioned on the two sides of the displacement element 20. Wherein the two sides of the displacement element 20 optionally have embedding grooves (not shown in the figures) for embedding the top sides of the two first elastic plates 42a and 42b into the embedding grooves. The second elastic plate 44a is positioned on a side of the first elastic plate 42a. The valve mechanism 10 of the disclosure further optionally has a base 12, an outer shape of the base 12 is, for example, but not limited to, slightly U-shaped, and two sides are higher and a central area is lower, second sides (e.g., bottom sides) of the two first elastic plates 42a and 42b and the second elastic plate 44a are disposed on the base 12 (e.g., side bottom edges of the base 12), wherein the displacement element 20 is suspended above the base 12 by a distance (e.g., the spacing D1), and the two carrier plates 40a and 40b are disposed above the base 12 and positioned on the two sides of the displacement element 20 through the two first elastic plates 42a and 42b and the supporting element 21. The second sides (e.g., the bottom sides) of the two first elastic plates 42a and 42b and the second elastic plate 44a, and the base 12 respectively have openings 14, and forms (e.g., shape and size) of the openings 14 could be the same or different from one another, and are, for example, but not limited to, the same as the first opening port 110a and the second opening port 110b. When the sealing disc 60 hard seals the first opening port 110a on the cavity 100, positions of the openings 14 are offset from a position of the first opening port 110a, such as completely offset or partially offset, wherein the disclosure is illustrated by completely offsetting, but is not limited thereto. The first elastic plate 42b, the first elastic plate 42a and the second elastic plate 44a are respectively positioned on two opposite side surfaces of the base 12, wherein the first elastic plate 42a and the second elastic plate 44a are positioned on a same side of the base 12 and a fixing block 43 is optionally provided between the first elastic plate 42a and the second elastic plate 44a. A thickness of the fixing block 43 could make the first elastic plate 42a and the second elastic plate 44a separated by a spacing D4. Moreover, the disclosure could adjust a spacing between the sealing disc 60 and the first opening port 110a by adjusting a thickness of the fixing block 43, so that the guide element 80 could correctly and precisely guide an orientation of the sealing disc 60.

In addition, a bottom side of the displacement element 20 of the disclosure could optionally have a plug pin 28, but is not limited thereto, and the base 12 could optionally have a guide slot 18, but is not limited thereto, for example, positioned on two top sides of the base 12, wherein a depth of the guide slot 18 is preferably, but not limited to being the same as the spacing D1, and the displacement element 20 could be more stably moved positionally in the first reciprocating motion M1 (spacing D1) by the plug pin 28 stably moving positionally in the guide slot 18. In other words, when the plug pin 28 stably moves positionally in the guide slot 18, the two carrier plates 40a and 40b could also stably perform the third reciprocating motion M3 in opposite directions (e.g., directions of moving away from or approaching each other) along the second axial direction X (e.g., X-axis direction), thereby more stably enabling the sealing disc 60 to perform the fourth reciprocating motion M4 between the intermediate position WI and the hard-sealing position W2.

When the sealing disc 60 fully opens the first opening port 110a on the cavity 100, positions of the openings 14 on the second sides (e.g., the bottom sides) of the two first elastic plates 42a and 42b and the second elastic plate 44a, and the base 12 are moved to positions corresponding to the first opening port 110a on the cavity 100. The spacing D1 is provided between a second side (e.g., a bottom side) of the displacement element 20 and a first side (e.g., a top side) of the base 12, for example. Wherein, the displacement element 20 could use the supporting element 21 to respectively drive the two carrier plates 40a and 40b to perform the third reciprocating motion M3 in opposite directions along the second axial direction X by means of a distance difference (i.e., the spacing D1) between a first motion path of the first reciprocating motion M1 performed by the displacement element 20 along the first axial direction Z and a second motion path of the second reciprocating motion M2 performed by the two carrier plates 40a and 40b along the first axial direction Z, until the second side (e.g., the bottom side) of the displacement element 20 abuts against the first side (e.g., the top side) of the base 12.

The first embodiment of the disclosure uses a bent portion 48 on the second elastic plate 44a as the guide element 80, which could be any elastic plate with a bent shape, such as a spring. For example, the first elastic plate 42a has a flat and straight portion 45 extending along the first axial direction Z, and the second elastic plate 44a has a flat and straight portion 46 extending along the first axial direction Z. The second sides (e.g., the bottom sides) of the two first elastic plates 42a and 42b and the second elastic plate 44a are disposed on the base 12. In addition, in the first embodiment of the disclosure, the second elastic plate 44a mainly comprises the bent portion 48 and the flat and straight portion 46, and the bent portion 48 is positioned on the flat and straight portion 46 (e.g., a top side), wherein the bent portion 48 is, for example, but not limited to, integrally formed with the flat and straight portion 46. The sealing disc 60 is disposed on the bent portion 48 of the second elastic plate 44a and is movably positioned on a side of the carrier plate 40a, so that the bent portion 48 on the second elastic plate 44a could be used as the guide element 80. In one feasible mode of the first embodiment of the disclosure, the second elastic plate 44a is composed of the bent portion 48 and the flat and straight portion 46. The second elastic plate 44a of the disclosure is not limited to being composed of the flat and straight portion 46 and the bent portion 48, and the guide element 80 could be any elastic plate with a bending angle.

When the two carrier plates 40a and 40b are driven by the displacement element 20 to perform the third reciprocating motion M3 in opposite directions (e.g., moving away from each other) along the second axial direction X, the carrier plate 40a will also synchronously push the sealing disc 60 fixedly disposed on the bent portion 48 of the second elastic plate 44a, so that a moving trajectory (e.g., slightly arc-shaped) of the sealing disc 60 could just compensate for an orientation error that would otherwise occur. In other words, the disclosure could adjust an orientation of the sealing surface 62 of the sealing disc 60 by using the guide element 80 when (or at the moment) or before the sealing surface 62 of the sealing disc 60 is about to contact or just contacts the sealing surface 112 of the first opening port 110a on the cavity 100, that is, to make an orientation of the sealing surface 62 correspond to (e.g., parallel to) the sealing surface 112 of the first opening port 110a in advance. The bent portion 48 of the second elastic plate 44a is, for example, disposed on a top side of the flat and straight portion 46, and is bent (or, bent inward) from a bending point PO toward the carrier plate 40a at a bending angle θ, so that when the sealing disc 60 is in the intermediate position W1, a top (e.g., an uppermost end) of the sealing surface 62 of the sealing disc 60 will be farther away from the first opening port 110a on the cavity 100 than a bottom (e.g., a lowermost end). However, when the sealing disc 60 is about to reach or just reaches the hard-sealing position W2, an entire periphery (including top and bottom) of the sealing surface 62 of the sealing disc 60 will be parallel to the first opening port 110a on the cavity 100, thereby contacting the first opening port 110a through uniform stress distribution and contact pressure distribution at the same time. A numerical value of the bending angle θ is, for example, any numerical value between 0 degree and 180 degrees, preferably any numerical value between 0 degree and 90 degrees, and more preferably any numerical value between 0 degree and 30 degrees, for example, about 5 degrees. The sealing disc 60 is, for example, fixedly disposed on the bent portion 48 of the second elastic plate 44a, and an angle value of an elevation angle presented by the sealing surface 62 is, for example, substantially the same as an angle value of the bending angle θ of the bent portion 48. However, the disclosure is not limited thereto, and an angle value of an elevation angle of the sealing surface 62 could also be different from an angle value of the bending angle θ, depending on actual requirements. The disclosure utilizes a pre-pressing design in which the second elastic plate 44a is bent inward (for example, about 5 degrees), even if the carrier plate 40a is not parallel to the first opening port 110a when the carrier plate 40a is stretched (for example, an extent of an upper end of the carrier plate 40a is stretched more than an extent of a lower end), the sealing disc 60 could be parallel to the first opening port 110a when the sealing disc 60 is pushed and moved to reach the first opening port 110a.

In addition, a structural configuration of the bent portion 48 of the disclosure could be adjusted correspondingly according to configurations of other components of the valve mechanism 10. For example, the bending angle θ of the bent portion 48 is adjusted corresponding to a spacing D2 between the intermediate position W1 and the hard-sealing position W2 of the sealing disc 60, a length ratio of the bent portion 48 and the flat and straight portion 46 of the second elastic plate 44a is adjusted corresponding to the spacing D2 between the intermediate position W1 and the hard-scaling position W2, and/or a position of the sealing disc 60 disposing on the bent portion 48 is adjusted corresponding to a length ratio of the bent portion 48 and the flat and straight portion 46 of the second elastic plate 44a. A length of the flat and straight portion 45 of the first elastic plate 42a is, for example, but not limited to, greater than a length of the flat and straight portion 46 of the second elastic plate 44a. In other words, the second elastic plate 44a is not limited to a specific form, as long as an orientation of the sealing surface 62 of the sealing disc 60 could be pre-guided when (or at the moment) or before the sealing disc 60 contacts the first opening port 110a on the cavity 100, it falls within a scope of protection claimed by the disclosure. Similarly, the two first elastic plates 42a and 42b of the disclosure are not limited to a specific form, any structure that could support the two carrier plates 40a and 40b could be applied to the disclosure.

In the first embodiment of the disclosure, the valve mechanism 10 further optionally comprises a pressing disc 68, and the pressing disc 68 is disposed on one of the two carrier plates 40a and 40b (e.g., the carrier plate 40b). When the two carrier plates 40a and 40b perform the third reciprocating motion M3, the sealing disc 60 and the pressing disc 68 respectively perform the fourth reciprocating motion M4 in opposite directions (e.g., in directions away from each other), so as to respectively abut against the first opening port 110a and the second opening port 110b on the cavity 100 when the valve mechanism 10 hard seals the cavity 100. A structural configuration of the pressing disc 68 could be, for example, the same as or different from that of the sealing disc 60. The first embodiment of the disclosure is illustrated by taking the pressing disc 68 as the same as the sealing disc 60 as an example, but is not limited thereto.

When the displacement element 20 performs the first reciprocating motion M1 and moves from the fully retracted height H1 to the fully extended height H3, a numerical value of the spacing D1 between the second side (e.g., the bottom side) of the displacement element 20 and the first side (e.g., the top side) of the base 12 is a fixed value when and before the displacement element 20 reaches the fully extended height H3. That is, when and before the base 12 contacts a bottom side of the cavity 100, the first reciprocating motion M1 of the displacement element 20 does not drive the two carrier plates 40a and 40b to perform the third reciprocating motion M3. A numerical value of the spacing D1 is, for example, adjusted according to a required path length of the third reciprocating motion M3, and could be, for example, an arbitrary preset value. When the base 12 contacts the bottom side of the cavity 100 (i.e., the cavity bottom 106), the displacement element 20 will reach the semi-extended height H2, and the sealing disc 60 will be positioned at the intermediate position W1. A feature of the disclosure is that the displacement element 20 could further utilize the spacing D1 to continue the first reciprocating motion M1 until the second side (e.g., the bottom side) of the displacement element 20 abuts against the first side (e.g., the top side) of the base 12 (i.e., the displacement element 20 reaches the fully extended height H3). In other words, after the base 12 contacts the cavity 100 (i.e., the semi-extended height H2), if the displacement element 20 continues to move toward the fully extended height H3, a distance (i.e., the spacing D1) between the displacement element 20 and the base 12 will gradually decrease, so the displacement element 20 could synchronously drive the two carrier plates 40a and 40b to perform the third reciprocating motion M3 along the second axial direction X in opposite directions (e.g., in directions away from each other) through the supporting element 21. At the same time, the sealing disc 60 and the pressing disc 68 could correspondingly perform the fourth reciprocating motion M4 in directions away from each other through the third reciprocating motion M3 of the carrier plates 40a and 40b. In other words, when the displacement element 20 moves to reach the fully extended height H3, a numerical value of the spacing D1 will drop to 0 (i.e., the displacement element 20 contacts the base 12), and at this time, the sealing disc 60 and the pressing disc 68 will just move to reach the hard-sealing position W2.

In other words, during a process of the valve mechanism 10 of the disclosure sealing the first opening port 110a, after the base 12 abuts against a bottom of the cavity 100 along with the first reciprocating motion M1 of the displacement element 20, the displacement element 20 could still continue to move within the spacing D1, and then push outward away from the two carrier plates 40a and 40b. At the same time, the two first elastic plates 42a and 42b and the second elastic plate 44a positioned on two sides of the two carrier plates 40a and 40b could also accumulate elastic potential energy. Similarly, when the valve mechanism 10 needs to open the first opening port 110a on the cavity 100 (that is, when the driving device 120 drives the displacement element 20 to perform the first reciprocating motion M1 from the fully extended height H3 toward the fully retracted height H1), the sealing disc 60 and the pressing disc 68 could move from the hard-sealing position W2 to the intermediate position WI by an elastic potential energy released by the two first elastic plates 42a and 42b and the second elastic plate 44a.

It could be known from the above that the first embodiment of the valve mechanism 10 of the disclosure uses the bent portion 48 positioned on the second elastic plate 44a as the guide element 80. By pre-adjusting a moving trajectory of the sealing surface 62 of the sealing disc 60 when performing the fourth reciprocating motion M4, the sealing surface 62 could contact horizontally and apply force horizontally to seal the first opening port 110a (referred to as horizontal sealing or parallel sealing), and could achieve good contact with the first opening port 110a through uniform stress distribution and contact pressure distribution, which could undoubtedly effectively reduce the common abrasion phenomenon in the conventional non-horizontal sealing technology. Therefore, the valve mechanism 10 of the disclosure could achieve a technical effect of automatically or actively guiding the sealing disc 60, and could even become an all-metal valve with automatic or active guiding design. Furthermore, the valve mechanism 10 of the disclosure could effectively solve the common problem of the supporting element 21 falling off by improving a structural design of the supporting element 21.

When the sealing disc 60 of the valve mechanism 10 of the disclosure is used for vacuum sealing, the sealing disc 60 of the disclosure could not only withstand a closing force F applied to the sealing disc 60 from the cavity 100 internally, but also withstand an atmospheric pressure applied to the sealing disc 60 from the cavity 100 externally when the cavity 100 is in a vacuum state. The higher a vacuum level of the cavity 100, the higher the closing force F and the atmospheric pressure mentioned above. For example, when the sealing disc 60 is a stainless steel metal with a thickness of about 1.8 mm, the closing force F that could be borne could reach about 500 Kg, and when evacuated, a vacuum level could reach about 7.33×10⁻¹¹ torr. The disclosure could be applied to an all-metal high-frequency shield gate valve installed in an electron beam channel of a superconducting accelerator. It is obvious that various functions and indicators of the sealing disc 60 of the disclosure, such as sealing performance, cleanliness and structural strength, do meet specification requirements of an ultra-high vacuum valve body. The sealing surface 62 of the sealing disc 60 could be, for example, but is not limited to, an inclined surface, an arc surface, or a spherical surface. When the sealing disc 60 enters the hard-sealing position W2 from the intermediate position W1, the sealing surface 62 of the sealing disc 60 could contact the sealing surface 112 on the first opening port 110a of the cavity 100. Therefore, even if the closing force F applied from the cavity 100 internally causes the sealing disc 60 to slightly deform elastically, the sealing surface 62 could still rotatably abut the sealing surface 112 to constantly maintain a vacuum sealing performance. Therefore, the disclosure could improve a sealing performance and extend a service life by a compensating movement and an adjusting movement when the sealing surfaces of metal materials abut each other, and could avoid abrasion between metals due to collision.

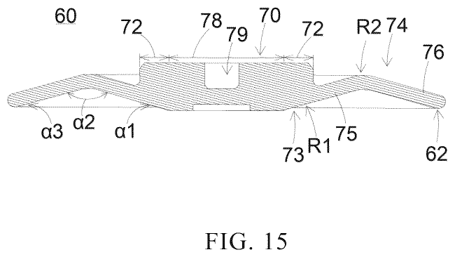

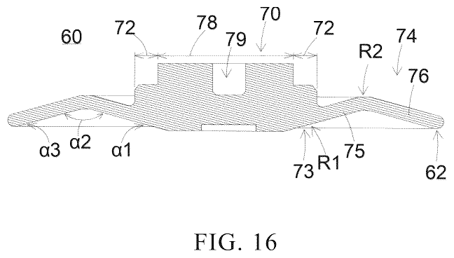

Please refer to FIG. 15 and FIG. 16 and other figures, a first implementation mode of the sealing disc 60 of the valve mechanism 10 of the disclosure comprises a base 70 and a sealing plate 74, wherein the base 70 comprises a coupling seat 78 and an auxiliary seat 72, the auxiliary seat 72 is integrally and annularly disposed on a side of the coupling seat 78, bottom sides (i.e., top of the drawings) of the auxiliary seat 72 and the coupling seat 78 have a same surface height (as shown in FIG. 15) or different surface heights (as shown in FIG. 16), and the auxiliary seat 72 has an annular inclined surface 73 positioned on a top side. The sealing plate 74 is annularly connected with the auxiliary seat 72 of the base 70, wherein the sealing surface 62 of the sealing disc 60 is rotatably abutted against the sealing surface 112 on the first opening port 110a of the cavity 100 at the hard-sealing position W2, so as to maintain a vacuum sealing of the first opening port 110a.

The sealing plate 74 of the sealing disc 60 of the valve mechanism 10 of the disclosure comprises a first wing plate 75 and a second wing plate 76. The first wing plate 75 is integrally and annularly connected to the auxiliary seat 72 of the base 70 at a first ring joint R1, and extends outwardly at a first included angle α1 in a direction away from the first ring joint R1, wherein the first wing plate 75 is obliquely extended outwardly from a top side of the base 70 toward a bottom side of the base 70. The second wing plate 76 is integrally and annularly connected to the first wing plate 75 at a second ring joint R2, and extends outwardly at a second included angle α2 in a direction away from the base 70, wherein the second wing plate 76 is obliquely extended outwardly from the bottom side of the base 70 toward the top side of the base 70, wherein the sealing surface 62 of the sealing disc 60 is positioned on an end edge of the second wing plate 76, and a third included angle α3 is formed between the second wing plate 76 and the sealing surface 62 of the sealing plate 74.

Wherein the coupling seat 78 is a first cylinder having a coupling hole 79, and the auxiliary seat 72 is a second cylinder having an annular inclined surface 73. An inclination of the annular inclined surface 73 of the auxiliary seat 72 is the same as an inclination (the first included angle α1) of the first wing plate 75. Wherein an angle value of the first included angle α1 is between 5 degrees and 45 degrees, and could be any numerical value in between. An angle value of the third included angle α3 is between 5 degrees and 45 degrees, and could be any numerical value in between. A sum of angle values of the first included angle α1, the second included angle α2, and the third included angle α3 is 180 degrees. An angle value of the first included angle α1 is, for example, the same as an angle value of the third included angle α3 . In various feasible implementation modes of the sealing disc 60 of the disclosure, in terms of outer shape, a cross-sectional shape of the sealing plate 74 of the sealing disc 60 could be, for example, a bent plate, a corrugated plate, an arc plate or a wing plate, which could increase a structural strength and a structural rigidity, that is, increase a structural toughness, so that the sealing disc 60 becomes a tough structure that retains both strength and rigidity, but the disclosure is not limited to the above examples. A thickness of the first wing plate 75 is, for example, but not limited to, the same as a thickness of the second wing plate 76. A common projection length of the first wing plate 75 and the auxiliary seat 72 is, for example, but not limited to, the same as a projection length of the second wing plate 76. A common projection length of the first wing plate 75 and the auxiliary seat 72 is approximately between 0.8 and 1.5 times a projection length of the second wing plate 76, and could be any numerical value in between. A projection length of the base 70 is approximately between 1 and 5 times a common projection length of the first wing plate 75 and the auxiliary seat 72, and could be any numerical value in between. However, the above numerical values are only examples and are not used to limit the disclosure. The sealing surface 62 of the sealing plate 74 of the sealing disc 60 of the disclosure could be optionally subjected to mechanical processing procedures such as lubrication and polishing. Preferably, dry polishing technology is used, such as dry blasting technology or fluid-jet polishing technology, by spraying abrasive particles to reduce surface roughness and increase lubricity, a surface roughness (Ra) is preferably less than about 0.3 μm, and more preferably less than about 0.1 μm.

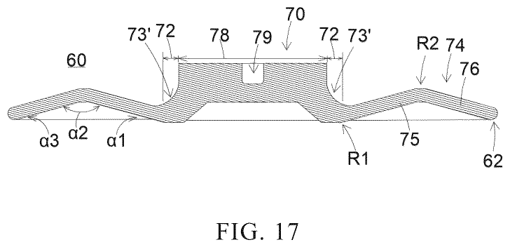

Please refer to FIG. 17 and other figures, the sealing disc 60 of the valve mechanism 10 of the disclosure further comprises a second implementation mode, wherein the second implementation mode is mostly the same as the first implementation mode, a difference is that the auxiliary seat 72 has an annular concave surface 73′ positioned on a bottom side (i.e., top of the drawing), so surface heights of bottom sides (i.e., top of the drawing) of the auxiliary seat 72 and the coupling seat 78 are different, wherein the auxiliary seat 72 is an annular arc body positioned on a side of the coupling seat 78.

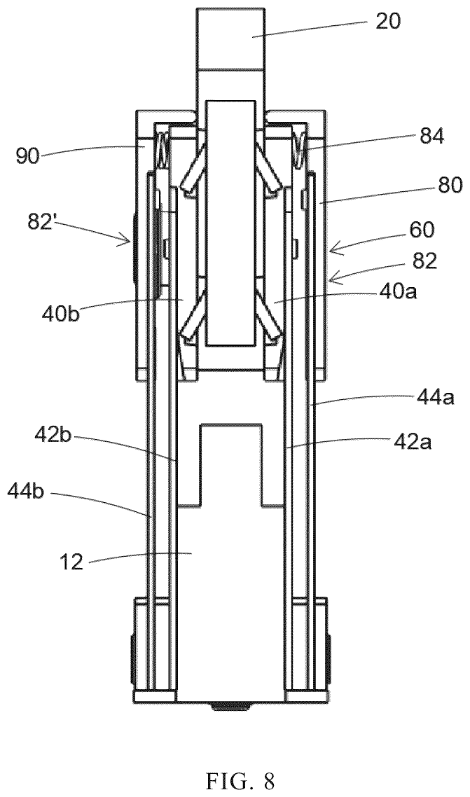

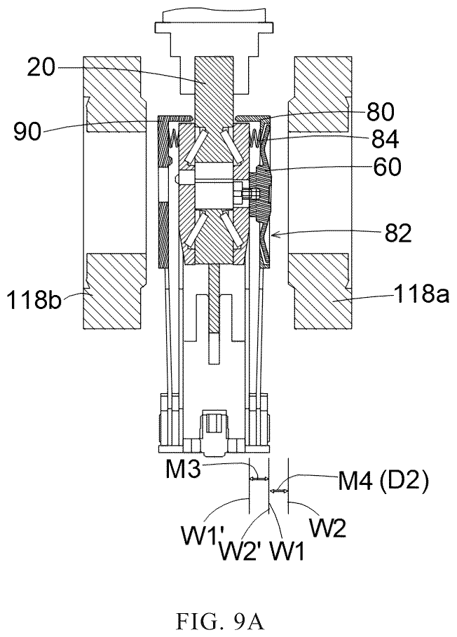

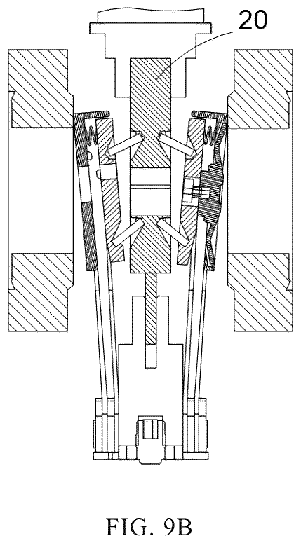

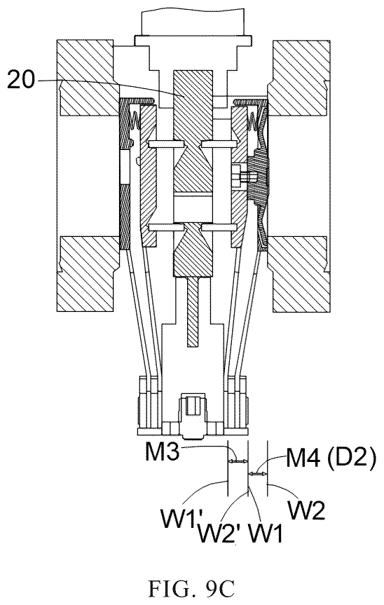

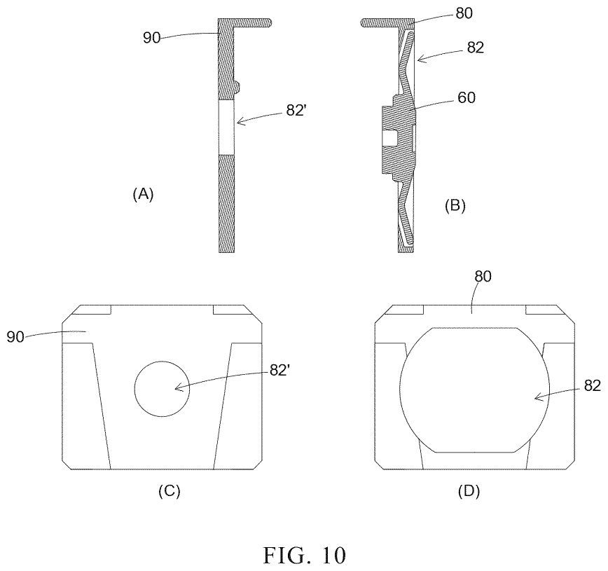

In addition, please refer to FIGS. 7 to 10 and other figures. The valve mechanism 10 of the disclosure has a second embodiment, and its difference from the first embodiment is that the scaling disc 60 is fixedly disposed on one of the two carrier plates 40a and 40b (e.g., the carrier plate 40a), the two carrier plates 40a and 40b are respectively disposed on the first sides (e.g., the top sides) of the two first elastic plates 42a and 42b, the two first elastic plates 42a and 42b respectively have the flat and straight portion 45 extending along the first axial direction Z, the two second elastic plates 44a and 44b respectively have the flat and straight portion 46 extending along the first axial direction Z, and the second sides (e.g., the bottom sides) of the two first elastic plates 42a and 42b and the two second elastic plates 44a and 44b are disposed on the base 12.

In the second embodiment, the disclosure uses a plate body (or a sleeve frame) with a groove 82 as the guide element 80. The guide element 80 is disposed on the first side (e.g., the top side) of the second elastic plate 44a, and the guide element 80 abuts against one of the two carrier plates 40a and 40b (e.g., 40a) via at least one reset element 84, so that the guide element 80 could abut against the carrier plate 40a via the reset element 84, thereby indirectly adjusting an orientation of the sealing surface 62 of the sealing disc 60 disposed on the carrier plate 40a. A shape of the guide element 80 with the groove 82 could surround the sealing disc 60 therein, and abuts against the first opening port 110a before the sealing disc 60 to facilitate subsequent guide actions. For example, a thickness of the guide element 80 could be optionally designed to be just a distance between the carrier plate 40a and the first opening port 110a in a hard sealing state, but is not limited thereto.

In detail, when the carrier plate 40a performs the third reciprocating motion M3, since the guide element 80 is positioned on an outer side of the sealing disc 60, the guide element 80 could contact the cavity 100 earlier than the sealing disc 60, so as to abut against the carrier plate 40a through the reset element 84 (that is, the reset element 84 could force the carrier plate 40a to rotate an angle) according to an orientation of the sealing surface 112 of the first opening port 110a on the cavity 100, thereby guiding an orientation of the sealing surface 62 of the sealing disc 60 provided on the carrier plate 40a. The at least one reset element 84 is, for example, a spring (e.g., a short spring or a push spring) or other elastic element or elastic push element with a preset elastic coefficient (e.g., about 50 N/mm). The reset element 84 is, for example, disposed on a peripheral side of the plate body of the guide element 80, such as an upper edge side, and is positioned between the carrier plate 40a and the guide element 80. A number of the reset element 84 could be determined according to actual requirements, such as one, two, or more than two, so that the carrier plate 40a could be adjusted by a single-side or multi-sides (or single-orientation or multi-orientations) abutting method, thereby pre-adjusting an orientation of the sealing surface 62 of the sealing disc 60. The reset element 84 of the disclosure could provide a preset certain force to assist in guiding the carrier plate 40a when the carrier plate 40a moves toward the hard-sealing position W2, and to assist the second elastic plate 44a to close the carrier plate 40a when the carrier plate 40a is to be moved toward the intermediate position W1.

For example, the guide element 80 of the second embodiment is a plate body (or a sleeve frame) having the groove 82, an opening shape of the groove 82 corresponds to the sealing disc 60, and is annular, such as circular, for accommodating the sealing disc 60. The groove 82 of the guide element 80 has different opening inner diameters on two sides of its plate body, for example, but is not limited to, wherein an opening inner diameter of one side (e.g., an outer side) of the plate body is larger than a diameter of the sealing disc 60, and an opening inner diameter of another side (e.g., an inner side) of the plate body is smaller than a diameter of the sealing disc 60, wherein a shape of an inner edge surface of the groove 82 corresponds to the sealing disc 60, so that the sealing disc 60 could be movably limited in the groove 82 of the guide element 80, and a peripheral cross-sectional shape of the plate body of the guide element 80 is, for example, L-shaped or step shaped. The sealing disc 60 is fixedly disposed on one of the two carrier plates 40a and 40b (e.g., the carrier plate 40a) and is movably (e.g., flipped) positioned in the groove 82 of the guide element 80. The guide element 80 is abutted against the carrier plate 40a by a single side through the reset element 84 in order to flip the carrier plate 40a, thereby guiding an orientation of the sealing surface 62 of the sealing disc 60. In the second embodiment of the disclosure, the disclosure is described by taking the groove 82 of the guide element 80 having different opening inner diameters on two sides of the plate body as an example, but the disclosure is not limited to the above example, and the groove 82 on two sides of the plate body could also be provided with a same opening inner diameter In addition, the second embodiment of the disclosure could adjust a distance between the sealing disc 60 and the first opening port 110a by adjusting a thickness of the fixing block 43 positioned between the first elastic plate 42a and the second elastic plate 44a, so that after the guide element 80 first contacts the first opening port 110a, there is still enough distance to guide an orientation of the sealing disc 60.

In short, in the second embodiment of the valve mechanism 10 of the disclosure, relative positions and/or orientation relationships between the sealing disc 60 and the carrier plate 40a are fixed to each other, and relative positions and/or orientation relationships between the sealing disc 60 and the guide element 80 are changeable by flipping the carrier plate 40a, so that the guide element 80 could pre-adjust an orientation of the sealing surface 62 of the sealing disc 60 according to an orientation of the sealing surface 112 of the first opening port 110a, and guide the sealing surface 62 of the sealing disc 60 to be substantially (e.g., completely) parallel to the sealing surface 112 of the first opening port 110a, so as to contact the first opening port 110a in parallel through uniform stress distribution and contact pressure distribution.

In addition, in the second embodiment of the valve mechanism 10 of the disclosure, the guide element 80 is a plate body (or a sleeve frame) having the groove 82, and the guide element 80 could optionally have an extension plate 86 disposed horizontally (for example, vertically or at other included angles) on the plate body of the guide element 80, such as on a top side, so that a side shape of the guide element 80 is approximately L-shaped. A fitting surface of the plate body of the guide element 80 and the sealing surface 112 of the first opening port 110a on the cavity 100, for example, have corresponding shapes and structures. The extension plate 86 could provide a limiting function to limit the carrier plate 40a and the sealing disc 60 to specific positions (for example, limited to a space defined by the plate body and the extension plate 86, so that the guide element 80 maintains a constant distance from the carrier plate 40a and the sealing disc 60), thereby preventing the carrier plate 40a and the sealing disc 60 from being offset after the valve mechanism 10 performs opening and sealing actions, and contacting the first opening port 110a earlier than the guide element 80.

In addition, please refer to FIG. 7 to FIG. 10 and other figures, in another feasible mode of the second embodiment of the valve mechanism 10 of the disclosure, the valve mechanism 10 of the disclosure replaces the pressing disc 68 with a pressing plate 90, wherein the two carrier plates 40a and 40b are respectively disposed on the two first elastic plates 42a and 42b, the guide element 80 and the pressing plate 90 are respectively disposed on the two second elastic plates 44a and 44b and respectively abut the two carrier plates 40a and 40b with the at least one reset element 84, so that the guide element 80 and the pressing plate 90 could simultaneously abut the two sides of the cavity 100 along with the third reciprocating motion M3 of the two carrier plates 40a and 40b. In addition, the guide element 80 and the pressing plate 90 are, for example, plates (or called sleeve frame) having the groove 82 and a groove 82′, respectively, and their structural forms and outer surface forms could be the same or different from each other. The guide element 80 and the pressing plate 90 could respectively contact the first opening port 110a and the second opening port 110b on the cavity 100 by means of uniform stress distribution and contact pressure distribution. For example, a diameter of the groove 82′of the pressing plate 90 could be optionally smaller or larger than a diameter of the groove 82 of the guide element 80. Since a purpose of the pressing plate 90 is to replace the pressing disc 68, it is not necessary to carry the sealing disc 60, so the pressing plate 90 could optionally be provided with or without the groove 82′. In addition, the carrier plate 40a and the displacement element 20 of the disclosure could also optionally have holes for a locking tool (such as a screwdriver or a wrench) to pass through, so that the sealing disc 60 could be locked to a screw hole of the carrier plate 40a by a screw-fastening element (such as a bolt) through the holes of the carrier plate 40a and the displacement element 20. In addition, the second elastic plate 44a could optionally have a recessed area (not shown in the figures), so that when the first elastic plate 42a is in closely fitted with the second elastic plate 44a (i.e., when the sealing disc 60 hard seals the first opening port 110a), the recessed area could be used to accommodate protrusions on the carrier plate 40a that fix the second elastic plate 44a, thereby ensuring that no interference between parts occurs.

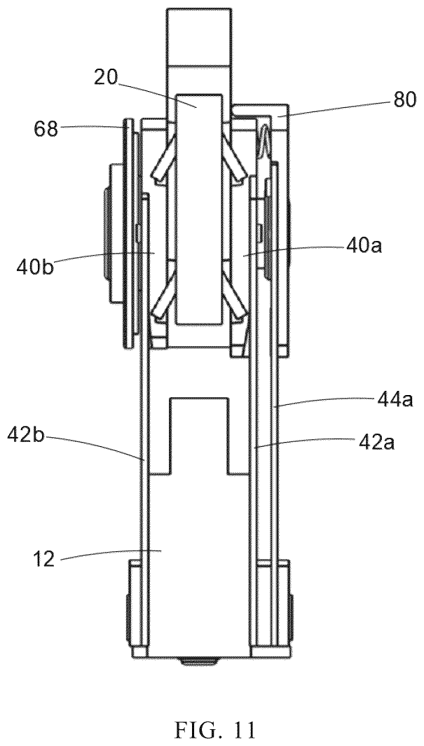

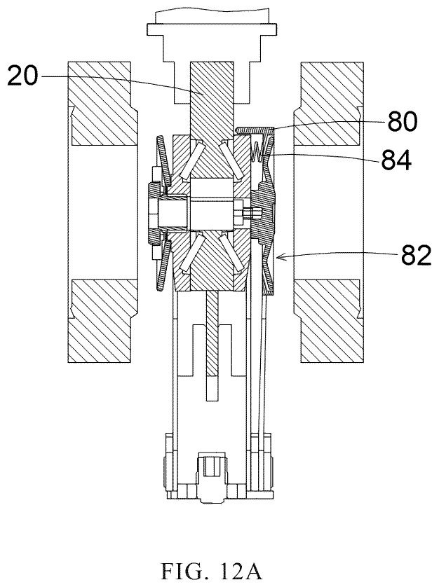

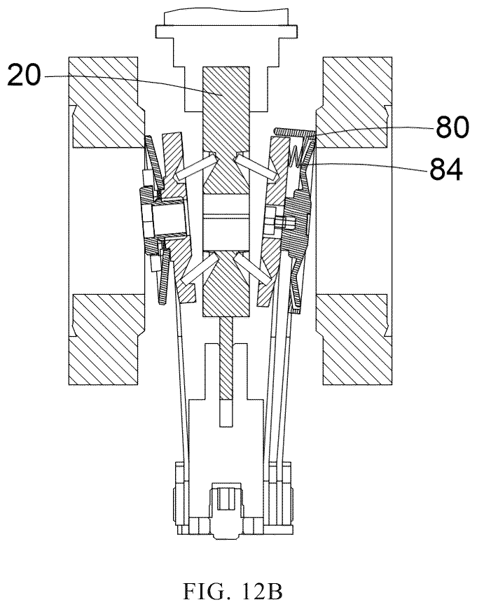

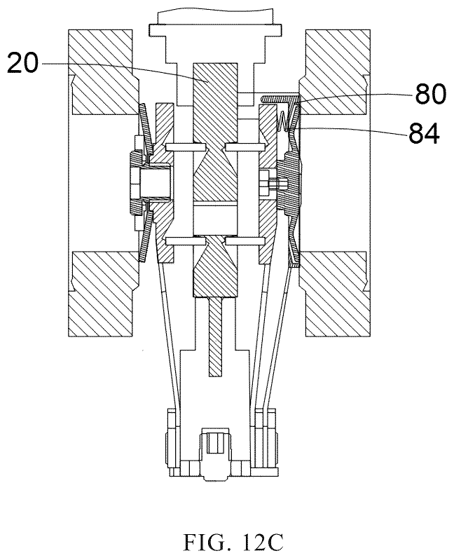

In a feasible mode of the second embodiment of the valve mechanism 10 of the disclosure, as shown in FIGS. 11 and 12A to 12C, the valve mechanism 10 further optionally comprises the pressing disc 68, wherein the pressing disc 68 is disposed on one of the two carrier plates 40a and 40b (e.g., the carrier plate 40b), the two carrier plates 40a and 40b are respectively disposed on the two first elastic plates 42a and 42b, and the guide element 80 is disposed on the second elastic plate 44a.

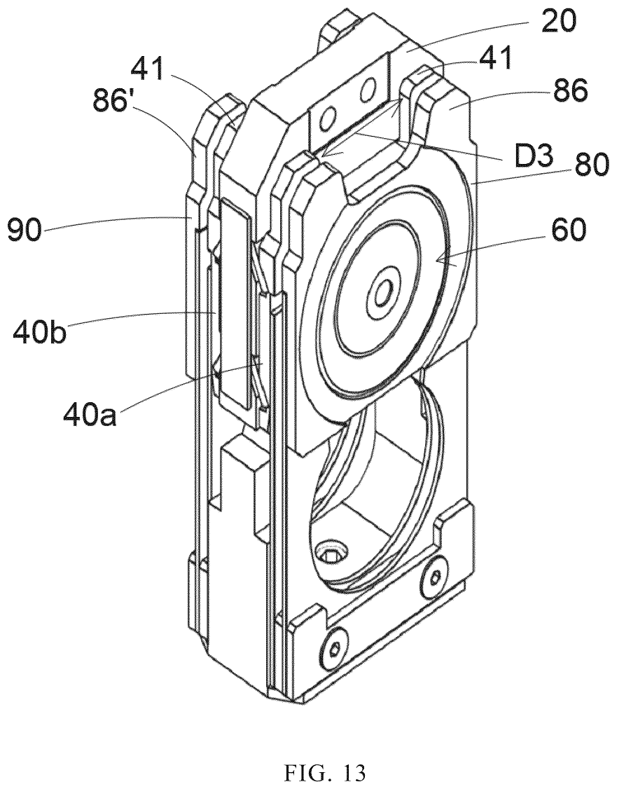

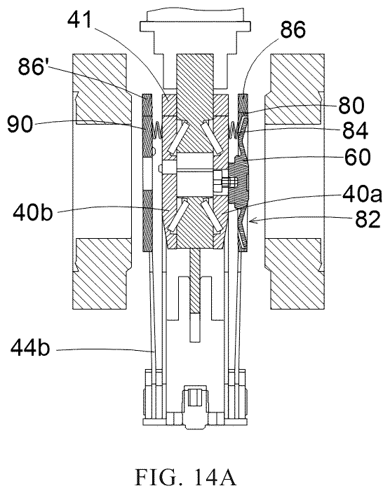

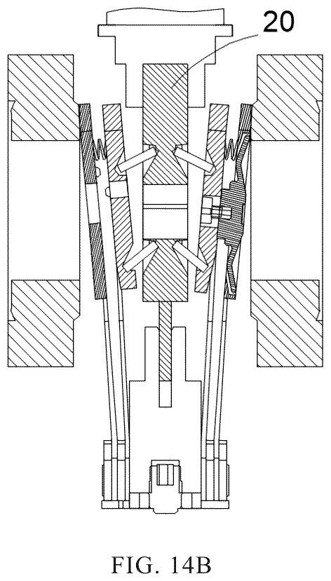

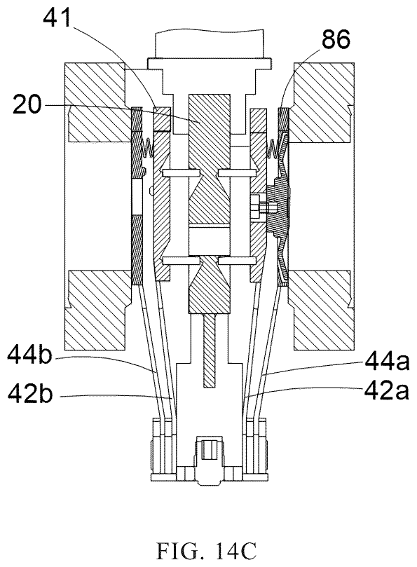

Please refer to FIG. 13, FIG. 14A, FIG. 14B, and FIG. 14C and other figures, a third embodiment of the valve mechanism 10 of the disclosure is substantially the same as the second embodiment, a difference is that the guide element 80 is a plate body (or referred to as a sleeve frame) with the groove 82, and the guide element 80 has the extension plate 86 disposed longitudinally (or referred to as, parallel or at other included angles) on the plate body (e.g., top side) of the guide element 80, thereby increasing a contact area and a force arm. The carrier plate 40a and/or 40b could optionally be provided with or without an extension plate 41 disposed longitudinally (or referred to as, parallel or at other included angles) on a plate body (e.g., top side) of the carrier plate 40a and/or 40b. The pressing plate 90 could also optionally have an extension plate 86′ disposed longitudinally (or referred to as, parallel or at other included angles) on a plate body (e.g., top side) of the pressing plate 90. Wherein the extension plate 86, for example, longitudinally protrudes from an outer side of the plate body of the guide element 80, so that a side shape of the guide element 80 is approximately I-shaped, thus an upper edge of the guide element 80 with the extension plate 86 could contact the first opening port 110a earlier than an upper edge of the guide element 80 without the extension plate 86, thereby the sealing disc 60 could be pre-guided to be parallel to the first opening port 110a at a position farther away from the first opening port 110a, and the extension plate 86 could increase a contact area between the guide element 80 and the first opening port 110a, so that a force is more uniform when the guide element 80 and the first opening port 110a are drawn closed to each other, and the extension plate 86 could increase a force arm of the guide element 80, so the reset element 84 could also use a spring with a smaller elastic coefficient. Disposing positions of the two reset elements 84 are, but not limited to, on the two extension plates 86. Wherein a number of the extension plate 86 is, for example, one or two. If the two extension plates 86 are provided, the two extension plates 86 could be optionally disposed on two sides of a top of the plate body of the guide element 80 in a manner of being separated by a spacing D3. The spacing D3 could be used as a displacement buffer space to avoid interference between the two reset elements 84 and the two carrier plates 40a and 40b. A numerical value of the spacing D3 could be any value, as long as avoidance of interference could be achieved, any numerical value could be applicable to the disclosure.

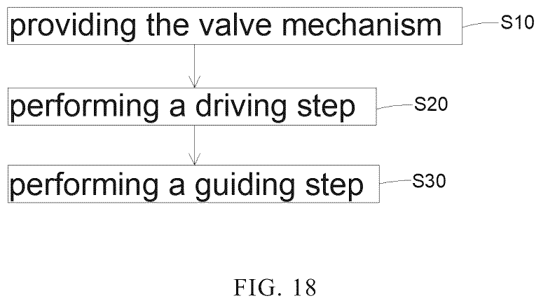

Please refer to FIG. 18 and other figures. An operating method of the valve mechanism 10 of the disclosure mainly comprises following steps of: providing the valve mechanism 10 described in the above-mentioned embodiments (step S10); performing a driving step (step S20) to enable the displacement element 20, the two carrier plates 40a and 40b, and the sealing disc 60 to respectively perform the first reciprocating motion M1, the second and third reciprocating motions M2 and M3, and the fourth reciprocating motion M4; and performing a guiding step (step S30) to enable the sealing disc 60 to contact the first opening port 110a on the cavity 100 through the guide element 80 in a manner of uniform stress distribution and contact pressure distribution to symmetrically apply force to seal the first opening port 110a. In detail, in the driving step (step S20), the valve mechanism 10 of the disclosure causing the displacement element 20 to perform the first reciprocating motion M1 along the first axial direction Z, so that the two carrier plates 40a and 40b performing the second reciprocating motion M2 along the first axial direction Z along with the first reciprocating motion M1 of the displacement element 20, and causing the displacement element 20 to further drive the two carrier plates 40a and 40b to perform the third reciprocating motion M3 in opposite directions along the second axial direction X, wherein the sealing disc 60 performs the second reciprocating motion M2 along the first axial direction Z along with the first reciprocating motion M1 of the displacement element 20, and the sealing disc 60 performs the fourth reciprocating motion M4 between the intermediate position W1 and the hard-sealing position W2 through the third reciprocating motion M3 of one of the two carrier plates 40a and 40b (e.g., the carrier plate 40b). In addition, in the guiding step (step S30), the guide element 80 guiding an orientation of the sealing surface 62 of the sealing disc 60 according to an orientation of the sealing surface 112 of the first opening port 110a on the cavity 100 during a process of the sealing disc 60 moving from the intermediate position W1 to the hard-sealing position W2, so that the sealing surface 62 of the sealing disc 60 being parallel to the sealing surface 112 of the first opening port 110a on the cavity 100, thereby symmetrically applying force to seal the first opening port 110a on the cavity 100.

In summary, A valve mechanism and an operating method of the same of the disclosure have the following advantages:

(1) The valve mechanism has a guide element (or correction element or orientation guide element), the guide element could pre-adjust (or correct) an orientation of a sealing disc disposed on a second elastic plate according to an orientation of a first opening port of a cavity when (or at the moment) or before the sealing disc contacts the first opening port, so that it remains completely parallel to the first opening port.

(2) The sealing disc could contact the first opening port on the cavity in parallel, and could contact the first opening port on the cavity in a manner of uniform stress distribution and contact pressure distribution to symmetrically apply force to seal the first opening port, and could reduce an abrasion caused by the sealing disc contacting the first opening port.

(3) The guide element of the valve mechanism could be a second elastic plate with a bending area, so as to achieve an efficacy of pre-adjusting (or correcting) an orientation of the sealing disc disposed on the second elastic plate.

(4) The guide element of the valve mechanism could be a sleeve frame, and has a reset element, which is used to abut against a carrier plate according to an orientation of the first opening port of the cavity, so as to achieve an efficacy of pre-adjusting (or correcting) an orientation of the sealing disc disposed on the carrier plate, and the guide element could optionally have a structural design that is completely fitted with the first opening port of the cavity.

(5) The guide element could have an extension plate extending outward in horizontal or vertical direction to prevent the sealing disc from contacting the first opening port of the cavity earlier than the guide element. By increasing a contact area, a force applied to the guide element and the first opening port could be more uniform when they are drawn closed to each other, and a spring with a smaller elastic coefficient could be used to increase a force arm.

(6) Using a tenon plate with a guide groove to replace part or all of supporting plates is conducive to solving a common problem of plate falling off when driving the supporting plate with conventional technology.

(7) The valve mechanism could use a pressing plate to replace a pressing ring to abut and connect with a second opening port on the cavity, so that a sealing performance of the sealing disc is no longer affected by a geometric shape of the abutting ring.

(8) Left and right offset of the valve mechanism in the cavity is very small. Compared with the conventional valve mechanism without a guide design, a centering performance of the valve mechanism of the disclosure has a significant leap in a movement process, so there is no need to worry about whether a geometric shape of the abutting ring will affect a sealing effect.

(9) The valve mechanism could realize a design principle of maintaining driving by a single driving device in a limited cavity space.

(10) The valve mechanism could be made of all-metal materials, wherein the sealing disc could directly abut a sealing surface of the first opening port of the cavity with its sealing surface to achieve a vacuum sealing effect, or even an ultra-high vacuum sealing effect, without additionally using gaskets or spacers. Even in an ultra-high vacuum environment, the sealing disc could still withstand a closing force applied to the sealing disc from a vacuum valve cavity internally and an atmospheric pressure applied to the sealing disc from a vacuum valve cavity externally. Moreover, the sealing surface of the sealing disc could rotate relative to the sealing surface of the first opening port of the cavity and always maintain contact, thereby providing a lubrication effect when the metal sealing surfaces abut each other, and also providing compensatory movement and adjustment movement, so as to improve a sealing performance and extend a service life, and further maintaining a vacuum sealing performance.

Note that the specification relating to the above embodiments should be construed as exemplary rather than as limitative of the present disclosure, with many variations and modifications being readily attainable by a person of average skill in the art without departing from the spirit or scope thereof as defined by the appended claims and their legal equivalents.

What is claimed is:

1. A valve mechanism configured for optionally sealing or opening a first opening port on a cavity, the valve mechanism comprising:
a displacement element configured for performing a first reciprocating motion along a first axial direction;
two carrier plates respectively movably located on two sides of the displacement element for performing a second reciprocating motion along the first axial direction along with the first reciprocating motion performed by the displacement element, and the displacement element further driving the two carrier plates to perform a third reciprocating motion in opposite directions along a second axial direction;
a sealing disc configured for performing the second reciprocating motion along the first axial direction along with the first reciprocating motion performed by the displacement element, and the sealing disc performing a fourth reciprocating motion between an intermediate position and a hard-sealing position correspondingly through the third reciprocating motion of one of the two carrier plates; and
a guide element configured for guiding an orientation of a sealing surface of the sealing disc correspondingly according to an orientation of a sealing surface of the first opening port on the cavity during a process of the fourth reciprocating motion performed by the sealing disc and moving from the intermediate position to the hard-sealing position, causing the sealing surface of the sealing disc to be parallel to the sealing surface of the first opening port on the cavity, thereby symmetrically applying force to seal the first opening port on the cavity.

2. The valve mechanism as claimed in claim 1, wherein the displacement element drives the two carrier plates to perform the third reciprocating motion in opposite directions along the second axial direction by means of a distance difference between a first motion path of the first reciprocating motion performed by the displacement element along the first axial direction and a second motion path of the second reciprocating motion performed by the two carrier plates along the first axial direction.

3. The valve mechanism as claimed in claim 2, wherein the displacement element uses at least one supporting plate, at least one tenon plate and/or the supporting plate and the tenon plate in the distance difference to respectively drive the two carrier plates to perform the third reciprocating motion in opposite directions along the second axial direction.

4. The valve mechanism as claimed in claim 2, wherein the two carrier plates are respectively disposed on first sides of two first elastic plates, the sealing disc is disposed on a first side of a second elastic plate or on one of the two carrier plates, the first elastic plate has a flat and straight portion extending along the first axial direction, the second elastic plate has a flat and straight portion extending along the first axial direction, and second sides of the two first elastic plates and the second elastic plate are disposed on a base.

5. The valve mechanism as claimed in claim 4, wherein the displacement element drives the two carrier plates to perform the third reciprocating motion in opposite directions along the second axial direction by means of the distance difference between the first motion path and the second motion path until the displacement element abuts against the base.

6. The valve mechanism as claimed in claim 4, wherein the second sides of the two first elastic plates and the second elastic plate and the base respectively have a groove, when the sealing disc seals the first opening port on the cavity, the grooves are staggered from the first opening port, when the sealing disc opens the first opening port on the cavity, positions of the grooves correspond to the first opening port on the cavity.

7. The valve mechanism as claimed in claim 4, wherein the second elastic plate further has a bent portion disposed on the flat and straight portion to serve as the guide element, and the sealing disc is disposed on the bent portion of the second elastic plate.

8. The valve mechanism as claimed in claim 7, wherein the bent portion of the second elastic plate is bent at a bending angle from a bending point toward one of the two carrier plates, so that when the sealing disc is in the intermediate position, a top of the sealing surface is farther away from the first opening port on the cavity than a bottom.

9. The valve mechanism as claimed in claim 8, wherein the bending angle of the bent portion is adjusted corresponding to a distance between the intermediate position and the hard-sealing position of the sealing disc, a length ratio of the bent portion to the flat and straight portion of the second elastic plate is adjusted corresponding to the distance between the intermediate position and the hard-sealing position, and/or a position of the sealing disc disposed on the bent portion is adjusted corresponding to the length ratio of the bent portion to the flat and straight portion of the second elastic plate.

10. The valve mechanism as claimed in claim 2, wherein the sealing disc is disposed on one of the two carrier plates, the guide element is disposed on the second elastic plate and abuts against one of the two carrier plates with at least one reset element, when one of the two carrier plates performs the third reciprocating motion, the guide element contacts the cavity earlier than the sealing disc, thereby using the reset element to push one of the two carrier plates according to the orientation of the sealing surface of the first opening port on the cavity, and guiding the orientation of the sealing surface of the sealing disc.

11. The valve mechanism as claimed in claim 10, wherein the guide element is a plate body having a groove, the sealing disc is disposed on one of the two carrier plates and is movably located in the groove of the guide element, and the guide element pushes one of the two carrier plates unilaterally through the reset element to flip one of the two carrier plates, thereby guiding the orientation of the sealing surface of the sealing disc.

12. The valve mechanism as claimed in claim 11, wherein the guide element further has an extension plate disposed horizontally or vertically on the plate body.

13. The valve mechanism as claimed in claim 11, wherein a fitting surface of the plate body of the guide element and a scaling surface of the first opening port on the cavity have corresponding shapes and structures.

14. The valve mechanism as claimed in claim 1, further comprising a pressing disc, the two carrier plates being respectively disposed on two first elastic plates, the sealing disc being disposed on a second elastic plate or one of the two carrier plates, the pressing disc being disposed on the other one of the two carrier plates, and the sealing disc and the pressing disc respectively performing the fourth reciprocating motion in opposite directions to abut against the first opening port and a second opening port on the cavity.

15. The valve mechanism as claimed in claim 1, further comprising a pressing plate, the two carrier plates being respectively disposed on two first elastic plates, the guide element and the pressing plate being respectively disposed on two second elastic plates and respectively abutting against the two carrier plates by at least one reset element, thereby the guide element and the pressing plate simultaneously abutting against two sides of the cavity along with the third reciprocating motion of the two carrier plates.

16. The valve mechanism as claimed in claim 15, wherein the guide element and the pressing plate are respectively a plate body having a groove.

17. The valve mechanism as claimed in claim 1, wherein the displacement clement is a plate body, the displacement element is driven by a driving device to perform the first reciprocating motion between a fully retracted height and a fully extended height, and the two carrier plates and the sealing disc perform the second reciprocating motion between the fully retracted height and the fully extended height along with the first reciprocating motion of the displacement element.

18. The valve mechanism as claimed in claim 1, wherein the valve mechanism is an all-metal valve.

19. The valve mechanism as claimed in claim 1, wherein the sealing disc comprises:
a base comprising a coupling seat and an auxiliary seat, the auxiliary seat is integrally and annularly disposed on a side of the coupling seat, surface heights of bottom sides of the auxiliary seat and the coupling seat are the same or different, and the auxiliary seat has an annular inclined surface positioned on a top side; and
a sealing plate, the sealing plate is annularly connected with the auxiliary seat of the base, wherein the sealing surface of the sealing disc is rotatably abutted against the sealing surface on the first opening port of the cavity at the hard-sealing position, so as to maintain a vacuum sealing of the first opening port.

20. The valve mechanism as claimed in claim 19, wherein the sealing plate comprises:
a first wing plate, the first wing plate is integrally and annularly connected to the auxiliary seat of the base at a first ring joint, and extends outwardly at a first included angle in a direction away from the first ring joint, wherein the first wing plate is obliquely extended outwardly from a top side of the base toward a bottom side of the base; and
a second wing plate, the second wing plate is integrally and annularly connected to the first wing plate at a second ring joint, and extends outwardly at a second included angle in a direction away from the base, wherein the second wing plate is obliquely extended outwardly from the bottom side of the base toward the top side of the base, wherein the sealing surface of the sealing disc is positioned on an end edge of the second wing plate, and a third included angle is formed between the second wing plate and the sealing surface of the sealing plate.

21. The valve mechanism as claimed in claim 20, wherein the coupling seat is a first cylinder having a coupling hole, and the auxiliary seat is a second cylinder having an annular inclined surface.

22. The valve mechanism as claimed in claim 20, wherein the coupling seat is a first cylinder having a coupling hole, and the auxiliary seat is an annular arc body positioned on the side of the coupling seat.

23. The valve mechanism as claimed in claim 20, wherein the first wing plate extends outwardly from a top side of the base obliquely toward a bottom side of the base, and the second wing plate extends outwardly from the bottom side of the base obliquely toward the top side of the base.

24. The valve mechanism as claimed in claim 20, wherein an angle value of the first included angle is between 5 degrees and 45 degrees, an angle value of the third included angle is between 5 degrees and 45 degrees, a sum of angle values of the first included angle, the second included angle, and the third included angle is 180 degrees.

25. The valve mechanism as claimed in claim 1, further comprising a pneumatic or an electric driving device for driving the displacement element to perform the first reciprocating motion along the first axial direction.

26. The valve mechanism as claimed in claim 25, wherein the pneumatic or electric driving device drives the displacement element fully or partially by manual control, automatic control or automatic pressure control (APC).

27. The valve mechanism as claimed in claim 25, wherein the pneumatic or electric driving device is a pneumatic driving cylinder, by controlling an air pressure or an airflow provided to the pneumatic driving cylinder, an effect of smooth closing, smooth opening or smooth actuation is achieved.

28. The valve mechanism as claimed in claim 27, further comprising a solenoid valve, a piezoelectric pressure regulating valve or a voice coil pressure regulating valve for controlling an air pressure or an airflow provided to the pneumatic driving cylinder.

29. The valve mechanism as claimed in claim 25, wherein during a process of the displacement element performing the first reciprocating motion along the first axial direction, the pneumatic or electric driving device drives the displacement element with a plurality of pressure values and/or speed values.

30. The valve mechanism as claimed in claim 25, wherein the pneumatic or electric driving device drives the displacement element by open-loop control or closed-loop control.

31. An operating method of the valve mechanism, comprising following steps of:
providing the valve mechanism as claimed in claim 1;
performing a driving step, causing the displacement element to perform the first reciprocating motion along the first axial direction, so that the two carrier plates performing the second reciprocating motion along the first axial direction along with the first reciprocating motion of the displacement element, and causing the displacement element to further drive the two carrier plates to perform the third reciprocating motion in opposite directions along the second axial direction, wherein the sealing disc performs the second reciprocating motion along the first axial direction along with the first reciprocating motion of the displacement element, and the sealing disc performs the fourth reciprocating motion between the intermediate position and the hard-sealing position through the third reciprocating motion of one of the two carrier plates; and
performing a guiding step, wherein the guide element guides the orientation of the sealing surface of the sealing disc according to the orientation of the sealing surface of the first opening port on the cavity during a process of the sealing disc moving from the intermediate position to the hard-sealing position, so that the sealing surface of the sealing disc is parallel to the sealing surface of the first opening port on the cavity, thereby symmetrically applying force to seal the first opening port on the cavity.
